(19) United States
(12) Patent Application Publication
(10) Pub. No.: US 2023/0117660 A1
(43) Pub. Date: Apr. 20, 2023

(54) SYSTEM AND METHOD FOR REPORTING AN ENVIRONMENT CHARACTERISTIC FROM A MAIN VEHICLE TO A CLOUD SERVER

(71) Applicant: TOYOTA MOTOR EUROPE, Brussels (BE)

(72) Inventors: Paul Girond, Brussels (BE); Christophe Gillet, Brussels (BE)

(73) Assignee: TOYOTA MOTOR EUROPE, Brussels (BE)

(21) Appl. No.: 17/909,538

(22) PCT Filed: Mar. 9, 2020
(86) PCT No.: PCT/EP2020/056198

§ 371 Date: Sep. 6, 2022

(51) Int. Cl. G08G 1/01; G08G 1/14; H04W 4/02; H04W 4/021

(52) U.S. Cl. CPC G08G 1/0112; G08G 1/147; G08G 1/0141; H04W 4/027; H04W 4/021

(57) ABSTRACT

A system for uploading data from a main vehicle to a cloud server is presented. The system includes a first sensor, a second sensor, a communication unit, and an electronic control unit. The first sensor obtains geo localization information of the main vehicle. The second sensor monitors first and second predetermined micro characteristics of the environment of the main vehicle. The communication unit transmits a report to an external cloud server and receives macro environment information indicating a predetermined macro characteristic of a geographic region in which the main vehicle is traveling. The electronic control unit repeatedly generates reports by collecting and buffering the first micro characteristic and transmits the reports in predetermined time intervals. The time intervals may be modified as a function of the second micro characteristic and the macro environment information.

### CROSS REFERENCE TO RELATED APPLICATION

This application is a National Stage of International Application PCT/EP2020/056198 filed on Mar. 9, 2020, the entire contents of which are hereby incorporated by reference.

### FIELD OF THE DISCLOSURE

The present disclosure is related to the field of mobile communication, in particular to a system and method for reporting an environment characteristic from a main vehicle to a cloud server.

### BACKGROUND OF THE DISCLOSURE

Recently, it has become popular to use vehicle as probes to take measurements/collect data of their environment, e.g. of the current traffic situation, or of free parking slots. In this context it is essential that the vehicles are equipped with a mobile communication system, e.g. a so-called telematics unit, for transmission of sampled data from the vehicle to a centralized server, i.e. a cloud server. Based on said collected data a map of the environment in which data have been collected may be established.

Furthermore the vehicle may log vehicle data which may be regularly reported to the cloud server for monitoring the vehicle state, e.g. in order to predict necessary maintenance services of the vehicle.

For example, modern vehicles are increasingly equipped with sensors and/or cameras and other optical sensors which are configured to acquire information of the vehicle and/or of the surrounding of the vehicle, e.g. data concerning the traffic situation around the vehicle.

It is further known to equip a vehicle with a geo localization sensor, e.g., a GPS sensor. In this way the collected data can be assigned with the current geo localizations before being transmitted to the cloud server.

However, the validity of the collected data (e.g. an empty parking slot information) can be time dependent. For this reason, there types of data (e.g. parking slot information) which require a quasi-real-time transmission or at least a timely transmission of the data. To ensure this data validity, mechanisms are put in place to plan the data sending at the best time (e.g. on periodic basis, after a specific event). However, those mechanisms rely on a stable communication. The quality of the mobile network used to transmit the data can though spatially and temporally change.

Moreover, data transmission incurs (network) costs and should therefore be limited to a necessary amount.

US2017329007A1 relates to a method for aiding finding of available parking areas of a street section includes receiving data corresponding to parking areas situated in a street section. The data include information ascertained by an ascertaining vehicle driving through the street section and information received from a server. The method further comprises determining an instantaneous occupancy estimate of the street section based on the received data, calculating a forecasted occupancy estimate based on the instantaneous occupancy estimate using a timer series forecasting model, and generating a display representation of the calculated forecasted occupancy estimate. The method includes receiving the data and determining the occupancy estimate, for example, each time an ascertaining vehicle drives through the street.

US2016033297A1 relates to an in-vehicle device that displays information on a facility around a vehicle, an information distribution server that distributes facility information, and a facility information display method of causing the in-vehicle device to display the facility information distributed by an information distribution server.

### SUMMARY OF THE DISCLOSURE

Currently, it remains desirable to provide a system and a method for uploading data from main vehicle to a cloud server in a reliable manner. In particular, it remains desirable to anticipate a potential loss of communication between the vehicle and the cloud server.

Therefore, according to the embodiments of the present disclosure, a system for uploading data from a main vehicle to a cloud server, the system being configured to be installed in the main vehicle, the system comprising:
a first sensor configured to obtain geo localization information of the main vehicle;
a second sensor configured to monitor at least one first predetermined micro characteristic of the current environment of the main vehicle, and configured to monitor at least one second predetermined micro characteristic of the main vehicle and/or of the current environment of the main vehicle;
a communication unit configured to transmit a report to an external cloud server via a wireless communications network and to receive macro environment information from the external cloud server via a wireless communications network, said macro environment information comprising (or representing) at least one predetermined macro characteristic of a geographic region in which the vehicle is traveling,
an electronic control unit configured to:
   repeatedly generate reports by collecting and buffering the at least one first monitored micro characteristic and transmit them in predetermined time intervals via the communication unit, and
   modify the predetermined time intervals as a function of the at least one second predetermined micro characteristic and the received macro environment information.

The geo localization information (e.g. GPS data) may be used to determine, whether the vehicle is in the macro environment or not.

The first predetermined micro characteristic may comprise information regarding free parking slots at which the vehicle passes during traveling.

The second predetermined micro characteristic may determine the micro environment of the vehicle, e.g. the current vehicle speed and/or the kind of road on which the vehicle is currently traveling and/or a traffic condition. Furthermore the predetermined micro characteristic may comprise a recognized traffic sign, lane marking, presence or not of vehicles, etc. Such data may though also be received from the cloud server.

Also the vehicle speed or other vehicle characteristics may (at least indirectly) describe the micro environment of the vehicle, as e.g. the speed may correspond to a city street or a highway.

The macro environment information may indicate a larger geographic region where the vehicle currently travels, e.g. a city or a specific countryside area. Said macro environment information may be determined by geolocalition and/or geofencing.

In the present disclosure the terms “micro” and “macro” may be understood as referring the geographic dimensions, wherein “micro” implies an area which is smaller than an area implied by the term “macro”, in a relative sense without necessarily defining absolute ranges. “Micro” may bence be understood as “related to a first smaller area” and “macro” as “related to a second area larger than the first region, which e.g. comprises the first smaller region”.

The predetermined time interval may be e.g. 30 sec or 1 min (or up to 5 min). If the time interval value is too high, then the micro information might not be valid anymore. Therefore a value below 5 min is desirable.

By providing such a system, it becomes possible to individually adapt the reporting activity of the vehicle, such that temporal data validity requirements of the sent data can be respected and at the same time no more data are transmitted, than necessary, in order to limit network load and data load on the cloud server.

Hence, by judging the validity of e.g. parking data (information regarding free parking slots) directly in the vehicle (and not in the cloud server), non-valid data can be prevented from being sent to the cloud. Hence, data communication costs and cloud server processing costs can be reduced.

Accordingly, data reports are not sent too often, as the data is buffered before being sent in a respective report. To avoid invalid parking data to be sent, an in-vehicle “Parking Data Valid” judgement may be made from cloud information (e.g. concerning macro level information) and/or from the second predetermined micro characteristic and/or map information in combination with the determined geo localization of the vehicle.

The first predetermined micro characteristic may comprise free parking slots, at which the main vehicle is passing during traveling.

The second predetermined micro characteristic of the current environment of the main vehicle may comprise a road type on which the main vehicle is traveling, and/or the second predetermined micro characteristic of the main vehicle may comprise a vehicle speed.

The at least one predetermined macro characteristic may indicate whether the geographic region is urban or not, e.g. above a predetermined urban threshold (e.g. determined based on given map data).

The electronic control unit may be configured to shorten a current time interval until the next report is to be transmitted, in case at least one the following conditions, in particular all conditions are fulfilled:
the first predetermined micro characteristic comprises free parking slots, at which the main vehicle is passing during traveling,
the second predetermined micro characteristic of the current environment of the main vehicle indicates a road type of a city street,
the second predetermined micro characteristic of the main vehicle indicates that the vehicle is traveling with less than a predetermined speed, e.g. 80 km/h,
the at least one predetermined macro characteristic indicates that the geographic region is urban.

The electronic control unit may be configured to pause the transmission of reports, in case at least one the following conditions, is not fulfilled:
the first predetermined micro characteristic comprises free parking slots, at which the main vehicle is passing during traveling,
the second predetermined micro characteristic of the current environment of the main vehicle indicates a road type of a city street,
the second predetermined micro characteristic of the main vehicle indicates that
the vehicle is traveling with less than a predetermined speed, e.g. 80 km/h,
the at least one predetermined macro characteristic indicates that the geographic region is urban.

The system may further comprise:
a data storage for storing street map data and/or the macro map information at least temporarily, wherein
the electronic control unit may be configured to:
localize the main vehicle on the street map based on the obtained geo localization information,
collect the first monitored micro characteristic during passing a predetermined first segment on street map and transmit the report at the end of the segment,
modify the predetermined time intervals as a function of the collected the first monitored micro characteristic.

The electronic control unit may be configured to:
predict the first monitored micro characteristic within a second distant segment in the traveling direction of the main vehicle based on the street map data,
modify the predetermined time intervals in addition as a function of the predicted the first monitored micro characteristic.

The communication unit may be configured to receive network information from the external cloud server via a wireless communications network, said network information comprising at least one locally varying characteristic of the wireless communications network across a geographic region.

The electronic control unit may be configured to modify the predetermined time intervals as a function of the received network information. the electronic control unit may be configured to:
predict the reliability of the wireless communications network in an anticipated traveling direction of the main vehicle as a function of the received network information and the obtained geo localization information, and
modify the predetermined time intervals as a function of the predicted reliability.

The electronic control unit may be configured to modify the predetermined time intervals, in case the received network information fulfills at least one of the following conditions:
the at least one locally varying characteristic indicates a signal quality and/or a signal strength below a respective predetermined threshold, and
the at least one locally varying characteristic indicates a reduced signal quality and/or a signal strength at a distance from the main vehicle below a predetermined distance threshold.

The system may further comprise a data storage for storing street map data, wherein
the electronic control unit may be configured to anticipate the traveling direction of the main vehicle based on the street map data.

The electronic control unit may be configured to segment the anticipated traveling route of the main vehicle into a plurality of route segments, wherein the predetermined time intervals are defined such that at the end of each route segment a report is transmitted.

The present disclosure may further relate to a vehicle comprising a system as described above.

The present disclosure further relates to a method of uploading data from main vehicle to a cloud server, the method comprising the steps of:
obtaining geo localization information of the main vehicle;
monitoring at least one first predetermined micro characteristic of the current environment of the main vehicle,
monitoring at least one second predetermined micro characteristic of the main vehicle and/or of the current environment of the main vehicle;
transmitting from the main vehicle a report to an external cloud server via a wireless communications network and receiving (at the main vehicle) macro environment information from the external cloud server via a wireless communications network, said macro environment information comprising at least one predetermined macro characteristic of a geographic region in which the vehicle is traveling,
repeatedly generating reports (at the main vehicle) by collecting and buffering the at least one first monitored micro characteristic and transmitting them in predetermined time intervals to the external cloud server, and
modifying the predetermined time intervals as a function of the at least one second predetermined micro characteristic and the received macro environment information.

The method may have further features and/or steps which correspond to the features and/or functions of the system as described above.

The present disclosure may further relate to a computer program including instructions for executing the steps of the method described above, when said program is executed by a computer.

Finally, the present disclosure may relate to a recording medium readable by a computer and having recorded thereon a computer program including instructions for executing the steps of the method described above, when said program is executed by a computer.

The system, as described above, may further comprise at least one of the following aspects:

The electronic control unit may further be configured to predict the reliability of the wireless communications network in an anticipated traveling direction of the main vehicle as a function of the received network information and the obtained geo localization information, and to modify the predetermined time intervals as a function of the predicted reliability.

The electronic control unit may further be configured to shorten a current time interval until the next report is to be transmitted, in case the predicted reliability of the wireless communications network in an anticipated traveling direction is below a predetermined reliability threshold.

The electronic control unit may further be configured to modify the predetermined time intervals, in case the received network information fulfills at least one of the following conditions:
the at least one locally varying characteristic indicates a signal quality and/or a signal strength below a respective predetermined threshold, and
the at least one locally varying characteristic indicates a reduced signal quality and/or a signal strength at a distance from the main vehicle below a predetermined distance threshold.

The system may further comprise a data storage for storing street map data, wherein the electronic control unit is configured to anticipate the traveling direction of the main vehicle based on the street map data.

The electronic control unit may further be configured to segment the anticipated traveling route of the main vehicle into a plurality of route segments, wherein the predetermined time intervals are defined such that at the end of each route segment a report is transmitted.

The length of a route segment, in particular of the current route segment, may be changed as a function of the predicted reliability of the wireless communications network.

The at least one predetermined characteristic of the main vehicle may comprise log data of vehicle operation.

The at least one predetermined characteristic of the main vehicle may comprise log data of vehicle operation. For example, these log data may comprise data collected by sensors, and/or actuator data, and/or diagnostic data. These data may be continuously received by the communication unit which samples the data.

The first sensor, the second sensor and the communication unit may be installed in or on the main vehicle.

The electronic control unit may be installed in the main vehicle or is external to the main vehicle, in particular comprised by the external cloud server.

The main vehicle and/or another vehicle may be configured to repeatedly measure and report the at least one locally varying characteristic of the wireless communications network to the cloud server during traveling.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, and serve to explain the principles thereof.

### BRIEF DESCRIPTION OF THE DRAWINGS

FIG. 1 shows a block diagram of a system according to embodiments of the present disclosure; and

FIG. 2 shows an exemplary scenario according to embodiments of the present disclosure in comparison to a default scenario.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

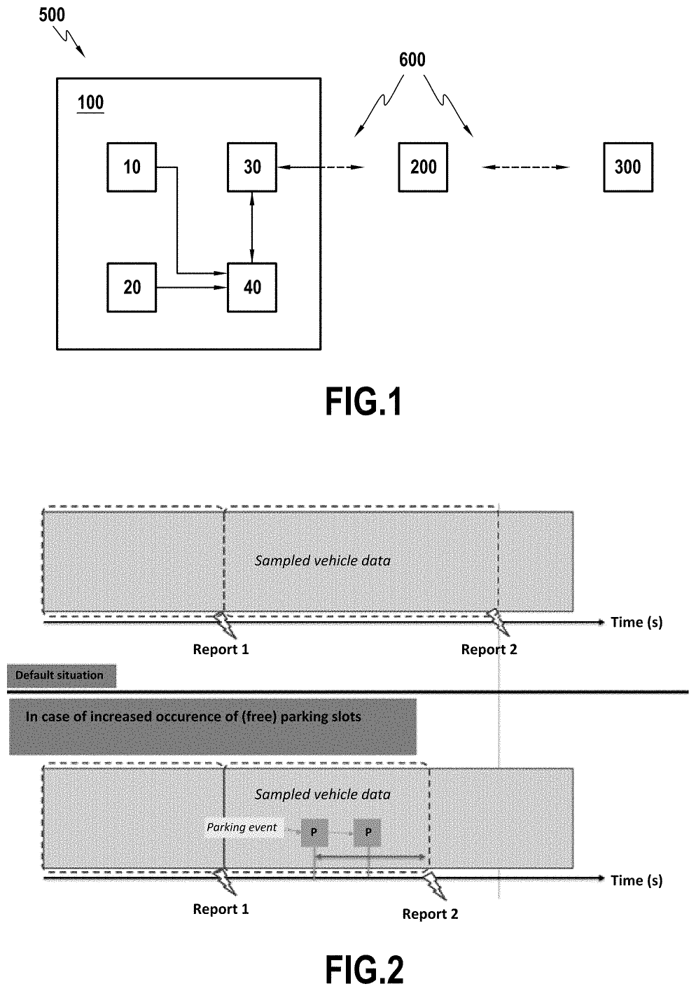

FIG. 1 shows a block diagram of a system 500 according to embodiments of the present disclosure. The system is configured to carry out the method according the present disclosure. In particular, the system may be configured to carry out computer instructions, i.e. for uploading data from a main vehicle 100 to a cloud server 200. The system 500 may comprise the cloud server 200 and/or vehicles 100, 300, etc. Alternatively the system 500 may consist of the vehicle 100. The vehicle 100 may be a robotic system, or the vehicle 100 may be an at least partially self-driving vehicle.

The system 500 comprises a first sensor 10 configured to obtain geo localization information (e.g. GPS) of the main vehicle 100. Said first sensor is desirably installed in the vehicle 100 but it may though also be external to the vehicle 100.

The system 500 further comprises a second sensor 20 configured to monitor at least one predetermined characteristic of the main vehicle and/or of the environment of the main vehicle. Said second sensor is desirably installed in the vehicle 100 but it may though also be external to the vehicle 100.

The second sensor may comprise e.g. one or several cameras and/or a speed sensor. For example, the system may comprise a plurality of cameras which together obtain a panoramic (e.g. 360°) image of the vehicle environment. The second sensor may be configured to detect e.g. free parking slots at which the vehicle passes during moving (i.e. at least one first predetermined micro characteristic of the current environment of the main vehicle). The second sensor may further be configured to monitor at least one second predetermined micro characteristic of the main vehicle, e.g. the vehicle speed during moving. Moreover the second sensor may be configured to monitor a predetermined micro characteristic of the environment of the vehicle, e.g. the kind of road on which the vehicle is moving (e.g. a high way or a city street), and/or a traffic condition (e.g. traffic jam).

For example, the data of the first and/or second sensor may be continuously received by an electronic control unit 40 which samples the data.

The system 500 further comprises a communication unit 30 (e.g. a telematics unit) configured to transmit a report to an external cloud server 200 and configured to receive macro environment information from the external cloud server via a wireless communications network. Said macro environment information comprises at least one predetermined macro characteristic of a geographic region in which the vehicle is traveling. For example said macro characteristic may indicate whether the vehicle is currently in a city (as e.g. Paris) or outside a city. Said macro information may be determined based on geolocalition and geofencing. Said communication unit 30 is desirably installed in the vehicle 100 but it may though also be external to the vehicle 100.

The system 500 further comprises an electronic control unit 40 configured to repeatedly generate reports by collecting and buffering the at least one first monitored micro characteristic and transmit the reports in predetermined time intervals via the communication unit 30. The time interval may be e.g. 30 sec or 1 min (up to 5 min). If the time interval value is however too high, then the micro information might not be valid anymore

The electronic control unit 40 modifies the predetermined time intervals as a function of the at least one second predetermined micro characteristic and the received macro environment information.

For example, if at least one second predetermined micro characteristic and/or the received macro environment information for a given at least one first monitored micro characteristic are invalid (e.g. vehicle outside a city, or vehicle on a downtown highway, or vehicle moving above a predetermined speed threshold), then the reporting frequency may be slowed down or reporting may be paused. Thanks to slowing reporting the costs for network traffic and cloud usage can be reduced.

Said electronic control unit 40 may be installed in the vehicle 100 but it may though also be external to the vehicle 100, e.g. a part of the cloud server 200.

For example the electronic control unit 40 may comprise a processor (e.g. at least one CPU) and a memory for storing instructions. The memory may be a non-volatile memory and it may comprise said instructions (or a computer program), e.g. of the method according the present disclosure, which can be executed by the processor for uploading data from the main vehicle to the cloud server in an individualized and anticipating way. It may further store map data, which can be used to determine the geo localization determined by the first sensor on a map.

The cloud server 200 may be furthermore in wireless connection with other vehicles 300, which are desirably configured like vehicle 100. The further vehicles 300 may also communicate over the same network 600 with the cloud server 200.

FIG. 2 shows an exemplary scenario according to embodiments of the present disclosure in comparison to a default scenario.

In the default scenario (shown on top in FIG. 2) the electronic control unit 40 regularly and repeatedly generates reports by collecting and buffering the at least one first monitored micro characteristic (e.g. free parking slot information) and transmit them in predetermined and fixed time intervals via the communication unit 30. Since the time intervals are fixed, it may occur that the report is to be sent at a time point and/or location where the micro environment previously passed by the main vehicle is not suitable to have the at least one first monitored micro characteristic (e.g. on a highway outside a city). Accordingly, said report may be sent without reason, thereby increasing network traffic and cloud usage. On the other hand, in e.g. a dense city area the fixed time interval may be too large, such that a sent report, once sent to the cloud server, comprises information which is not valid any more (i.e. out-dated).

In contrast, in the exemplary scenario according to embodiments of the present disclosure (shown on bottom of FIG. 2), the electronic control unit 40 determines in this example that the vehicles moves in an area with increased occurrence of the first monitored micro characteristic (here: increased number of parking slots). This determination may be based on at least one of: a determination that the vehicle currently travels in a city, a determination that the vehicle moves with less than a predetermined speed, as e.g. 80 km/h, a determination that the vehicle is on a city street and not on a city highway, a determination that the vehicle is not in a traffic jam, i.e. that the non-moving vehicles on left and/or right side are parked and not part of a traffic jam, and a determination of at least one free parking slot.

For this purpose the control unit may cut the intended travel route into segments, wherein at the end of each segment a report is sent. When it is determined that passed segments are within in an area with increased occurrence of the first monitored micro characteristic, the segments are made smaller, such that the frequency of sending reports is increased. In contrast, when it is determined that passed segments are within in an area with decreased occurrence of the first monitored micro characteristic, the segments are made larger, such that the frequency of sending reports is decreased.

The system 500 may anticipate the traveling direction of the main vehicle based on stored street map data, which may indicate areas where the occurrence of the first monitored micro characteristic increases or decreases. Said information may be use, as described above, i.e. to eventually change the frequency of report transmission.

Additionally or alternatively, the information received from the cloud server may be used. Accordingly, the main vehicle and/or another vehicle may repeatedly measure and report the at least one locally varying first micro characteristic of the wireless communications network to the cloud server during traveling. The cloud server may bence establish and keep updated a geographic map in the at least one locally varying first micro characteristic. Said information may be shared with the vehicle(s) which may use it, as described above, i.e. to eventually pull forward report transmission.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A system for uploading data from a main vehicle to a cloud server, the system being configured to be installed in the main vehicle, the system comprising:
a first sensor configured to obtain geo localization information of the main vehicle;
a second sensor configured to monitor at least one first predetermined micro characteristic of a current environment of the main vehicle, and configured to monitor at least one second predetermined micro characteristic of at least one of the main vehicle and of the current environment of the main vehicle;
a communication unit configured to transmit a report to an external cloud server via a wireless communications network and to receive macro environment information from the external cloud server via the wireless communications network, said macro environment information comprising at least one predetermined macro characteristic of a geographic region in which the main vehicle is traveling; and
an electronic control unit configured to:
repeatedly generate reports by collecting and buffering the at least one first monitored micro characteristic and transmit the generated reports in predetermined time intervals via the communication unit, and
modify the predetermined time intervals as a function of the at least one second predetermined micro characteristic and the received macro environment information.

2. The system according to claim 1, wherein the first predetermined micro characteristic comprises free parking slots, at which the main vehicle is passing during traveling.

3. The system according to claim 1, wherein the second predetermined micro characteristic of the current environment of the main vehicle comprises at least one of a road type on which the main vehicle is traveling and, a vehicle speed.

4. The system according to claim 1, wherein
the at least one predetermined macro characteristic indicates whether the geographic region is urban or not.

5. The system according to claim 4, wherein the electronic control unit is configured to shorten a current time interval until the next report is to be transmitted, in case at least one the following conditions is fulfilled:
the first predetermined micro characteristic comprises free parking slots, at which the main vehicle is passing during traveling,
the second predetermined micro characteristic of the current environment of the main vehicle indicates a road type of a city street,
the second predetermined micro characteristic of the main vehicle indicates that the main vehicle is traveling with less than a predetermined speed, and
the at least one predetermined macro characteristic indicates that the geographic region is urban.

6. The system according to claim 5, wherein
the electronic control unit is configured to pause the transmission of reports, in case at least one the following conditions, is not fulfilled:
the first predetermined micro characteristic comprises free parking slots, at which the main vehicle is passing during traveling,
the second predetermined micro characteristic of the current environment of the main vehicle indicates a road type of a city street,
the second predetermined micro characteristic of the main vehicle indicates that the main vehicle is traveling with less than the predetermined speed, and
the at least one predetermined macro characteristic indicates that the geographic region is urban.

7. The system according to claim 1, further comprising:
a data storage for storing at least one of street map data and macro map information at least temporarily, wherein
the electronic control unit is configured to:
localize the main vehicle on a street map based on the obtained geo localization information,
collect the first monitored micro characteristic during passing a predetermined first segment on street map and transmit the report at the end of the segment, and
modify the predetermined time intervals as a function of the collected the first monitored micro characteristic.

8. The system according to claim 7, wherein the electronic control unit is configured to:
predict the first monitored micro characteristic within a second distant segment in a traveling direction of the main vehicle based on the street map data, and
modify the predetermined time intervals in addition as a function of the predicted the first monitored micro characteristic.

9. The system according to claim 1, wherein
the communication unit is configured to receive network information from the external cloud server via the wireless communications network, said network information comprising at least one locally varying characteristic of the wireless communications network across geographic region, and
the electronic control unit is configured to:
modify the predetermined time intervals as a function of the received network information.

10. The system according to claim 1, wherein
the electronic control unit is configured to:
predict a reliability of the wireless communications network in an anticipated traveling direction of the main vehicle as a function of the received network information and the obtained geo localization information, and
modify the predetermined time intervals as a function of the predicted reliability.

11. The system according to claim 9, wherein
the electronic control unit is configured to modify the predetermined time intervals, in case the received network information fulfills at least one of the following conditions:
the at least one locally varying characteristic indicates at least one of a signal quality and a signal strength below a respective predetermined threshold, and
the at least one locally varying characteristic indicates at least one of a reduced signal quality and a signal strength at a distance from the main vehicle below a predetermined distance threshold.

12. The system according to claim 1, further comprising a data storage for storing street map data, wherein
the electronic control unit is configured to anticipate a traveling direction of the main vehicle based on the street map data.

13. The system according to claim 1, wherein
the electronic control unit is configured to segment an anticipated traveling route of the main vehicle into a plurality of route segments, wherein the predetermined time intervals are defined such that at the end of each route segment a report is transmitted.

14. A vehicle comprising a system for uploading data from the vehicle to a cloud server, the system comprising:
a first sensor configured to obtain geo localization information of the vehicle;
a second sensor configured to monitor at least one first predetermined micro characteristic of a current environment of the vehicle, and configured to monitor at least one second predetermined micro characteristic of at least one of the vehicle and the current environment of the vehicle;
a communication unit configured to transmit a report to an external cloud server via a wireless communications network and to receive macro environment information from the external cloud server via a wireless communications network, said macro environment information comprising at least one predetermined macro characteristic of a geographic region in which the vehicle is traveling; and
an electronic control unit configured to:
repeatedly generate reports by collecting and buffering the at least one first monitored micro characteristic and transmit the generated reports in predetermined time intervals via the communication unit, and
modify the predetermined time intervals as a function of the at least one second predetermined micro characteristic and the received macro environment information.

15. A method of uploading data from a main vehicle to a cloud server, the method comprising the steps of:
obtaining geo localization information of the main vehicle;
monitoring at least one first predetermined micro characteristic of a current environment of the main vehicle,
monitoring at least one second predetermined micro characteristic of at least one of the main vehicle and the current environment of the main vehicle;
transmitting from the main vehicle a report to an external cloud server via a wireless communications network and receiving macro environment information from the external cloud server via the wireless communications network, said macro environment information comprising at least one predetermined macro characteristic of a geographic region in which the main vehicle is traveling,
repeatedly generating reports by collecting and buffering the at least one first monitored micro characteristic and transmitting the generated reports in predetermined time intervals to the external cloud server, and
modifying the predetermined time intervals as a function of the at least one second predetermined micro characteristic and the received macro environment information.
